(19) United States
(12) Patent Application Publication
(10) Pub. No.: US 2019/0030946 A1
(43) Pub. Date: Jan. 31, 2019

(54) METHOD TO CREATE 3D HOLOGRAPHIC AND OTHER VISUAL AND TEXTURE EFFECTS ON CURABLE COSMETIC COATINGS

(71) Applicant: Coty Inc., New York, NY (US)

(72) Inventor: Yuemei Zhang, Ramsey, NJ (US)

(21) Appl. No.: 15/903,951

(22) PCT Filed: Sep. 8, 2016
(86) PCT No.: PCT/US2016/050749

§ 371 Date: Feb. 23, 2018

Related U.S. Application Data
(60) Provisional application No. 62/215,393, filed on Sep. 8, 2015.

(51) Int. Cl. B44F 1/02; B44C 1/24; A45D 29/00

(52) U.S. Cl. CPC B44F 1/02; B44C 1/105; A45D 29/00; B44C 1/24

(57) ABSTRACT

Inventive embodiments disclosed herein include a cosmetic device for imparting a three dimensional microscale design or impressing image such as holographic and other microstructure or refractive image to a cosmetic coating on a keratinous surface. The device includes a casting film having a surface defining a design having three dimensions, positionable over the keratinous surface, wherein the design faces and contacts a coating on the keratinous surface, the design transferred to the coating so that the casting film is removable from the coating after the coating is cured.

### CLAIM FOR PRIORITY

This Application claims the benefit of priority to U.S. Provisional Patent Application No. 62/215,393, filed Sep. 8, 2015, which is hereby incorporated by reference in its entirety.

### FIELD

Inventive subject matter disclosed herein relates to a method and device for making surface relief images, such as three-dimensional holographic and other visual and textural effects on curable cosmetic coatings and cosmetic coatings having the surface relief images.

### BACKGROUND

Conventional surface relief substrates are web-based films that have been embossed to depths that range from an Angstrom to a mil. The embossed designs have been made with uneven etch cuts, wide angles cuts, diffractive surfaces, prism effects and holographic effects.

### SUMMARY

Embodiments disclosed herein include a cosmetic device for imparting a surface relief image, such as a three dimensional design or texture or three dimensional hologram, to a cosmetic coating applied to a keratinous surface. The device includes a casting film having a surface defining a design having three dimensions, positionable over an uncured cosmetic coating, wherein the design faces and contacts the cosmetic coating applied to the keratinous surface, the design transferable to the coating so that the casting film is removable from the coating after the coating is cured. Once removed, a three dimensional design or texture or hologram is viewable and touchable on the cosmetic coating applied to the keratinous surface.

Another embodiment includes a cosmetic device for imparting a three dimensional design or three dimensional texture or three-dimensional holographic images to a cosmetic gel coating. The device includes a casting film having a surface defining a design having three dimensions, positionable on and into the cosmetic gel coating, wherein the design faces and contacts an uncured cosmetic gel coating, the design transferred to the gel coating so that the casting film is removable from the gel coating after the gel coating is cured. Once removed, the three dimensional design or texture or hologram is viewable and touchable on the cured cosmetic gel coating.

Another embodiment includes a method for imparting a three dimensional design to a cosmetic coating. The method includes the following: applying an ultraviolet gel to a mammalian nail; applying a casting film to the gel, the casting film having a surface defining a design having three dimensions, so that the surface defining the design faces and contacts the gel, wherein the design is transferred to the gel; applying ultraviolet energy to the gel and casting film, and removing the casting film, exposing the design.

Another embodiment includes a method for imparting a three dimensional design to a cosmetic coating. The method includes the following: applying a coating to a mammalian nail; applying a casting film to the coating, the casting film having a surface defining a design having three dimensions, so that the surface defining the design faces and contacts the coating, wherein the design is transferred to the coating; applying ultraviolet energy to the coating and casting film; and removing the casting film exposing the design.

### DESCRIPTION OF DRAWINGS

FIG. 1 is a flow chart view of a process embodiment for making a 3D holographic or other visual or texture effect on a curable cosmetic coating.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Inventive embodiments disclosed herein are related to a method for imparting three-dimensional effects on curable cosmetic coatings such as nail enamels, which have been applied to one or more nails, which are then cured. The three-dimensional effects are made with design thicknesses on a microscale, ranging from about one Angstrom to about one mil. Typically, consumers touching a three-dimensional effect on a cosmetic coating such as a nail enamel, would not feel any difference in thickness. The cured coating displays the three-dimensional effect. The term, cosmetic coatings, as used herein, refers to coatings applied to keratinous surfaces, such as fingernails and toenails. Cosmetic coatings are, for some embodiments, also applied to skin. Cosmetic coatings include films, polishes, and paint. Cosmetic coatings considered herein are curable.

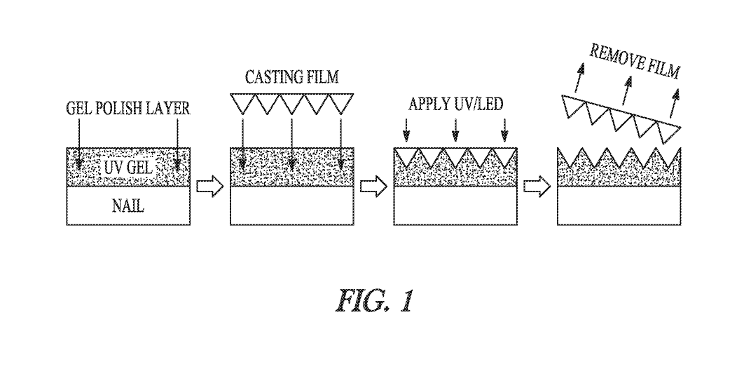

One method embodiment for imparting a three dimensional design to a cosmetic coating includes applying a curable gel cosmetic coating to a mammalian nail. In one embodiment, the gel cosmetic coating is curable with ultraviolet light. The method also includes applying a casting film to the curable gel cosmetic coating, the casting film having a surface defining a design having three dimensions, so that the surface defining the design faces and contacts the curable gel, wherein the design is transferred to the curable gel. Ultraviolet energy is applied to the gel cosmetic coating and casting film to cure the gel. The casting film is then removed, exposing the three dimensional design on the nail coating. These steps are shown in FIG. 1.

The three dimensional effects include three dimensional holographic images and other three dimensional visual and textural effects. The three dimensional and holographic effects are made, for some embodiments, by embossing a casting film so that one layer reflects light at an angle different from other surface portions having designs. The casting film includes, for some embodiments, visual and textural effects created by diffractive optical elements, jagged etch cuts, image-imparting prism etching, micro-angled cuts, and prism and holographic style effects. The casting film is usable to impart an embodiment of the three dimensional hologram or other visual or textural effect onto a cosmetic film that has been applied to a keratinous surface such as a nail. For some embodiments, the casting film is shaped for application to a fingernail or toenail. For some embodiments, the casting film includes at least one edge, free from a design, that can be touched and handled by human fingers.

Three dimensional designs are imparted to the casting film by conventional methods that include direct printing and reverse printing. Direct printing is similar to a conventional cast and cure process employed in the printing industry. For reverse printing, the cast film is used as a carrier web for printing.

One embodiment includes casting film made by a process that forms a uniform film surface that incorporates finishes such as ultra-high gloss, matte and holographic finishes on multiple substrate types. This casting film is created in both sheet-fed, offset, and web-fed, flexo and gravure environments. The particular effect embodiments are achieved by applying wet UV, ultraviolet curable, or EB, electron beam curable varnish to a substrate based on either spot or flood coverage needs. Once the varnish is applied, the film is temporarily laminated to the substrate within image or pattern, i.e. holographic, matte, or another pattern. The film acts as an embossing tool that manipulates the surface of the coating on a submicron scale. The lamination creates a “cased” image in the surface of the varnish, and then the varnish is UV or EB cured with the casting film still in place. Next, the film is delaminated and stripped away, leaving the desired pattern on the surface of the substrate, i.e. the casting film employed in inventive embodiments herein. No material or film is transferred to the surface, so the film can be rewound and used multiple times. Further details on this film making embodiment are disclosed in U.S. Pat. No. 7,887,722, which is incorporated herein by reference.

For some embodiments the cast film, having the desired design, includes a border or edge, for handling by human fingers. For other embodiments, the cast film is shaped like a fingernail.

These embodiments allow different nail polish systems to be used, including ultraviolet, solvent or water-based as long as the dried polish is hard and durable. As used herein, the terms, “nano embossing” and “nano imprint lithography” refer to structuring of polymer films that are thicker than the height of the patterns being embossed. One type of nano imprint lithography employed herein makes a hologram. The term, “hologram” as used herein, refers to a three-dimensional image formed by the interference of light beams from a laser or other coherent light source. For some embodiments, holographic effects are embossed facets on a casting film surface of variable depth. Other effects imparted by the cast film include color, and animation effects. Color does not require pigments.

The method for making a three-dimensional effect on a cosmetic coating includes employing a casting film with a three dimensional image, applying the casting film to a cosmetic coating before the coating has been cured; and subjecting the cosmetic coating to curing. In one embodiment, the curing is an ultraviolet curing. Once the cosmetic coating is cured, the casting film is removed from the cured cosmetic coating by peeling for some embodiments and rubbing for other embodiments. Visual effects imparted by the casting film to the cosmetic coating include color, image, texture, and animation effects in addition to three-dimensional holograms. The claimed method embodiments impart texturing and color to cosmetic coatings without use of pigments or actual texturizing.

Another embodiment includes a cosmetic device for imparting a three dimensional design to a cosmetic coating. The device includes a casting film having a surface defining a design having three dimensions, positionable over a nail, wherein the design faces and contacts a gel coating on the nail, the design transferred to the gel coating so that the casting film is removable from the gel coating after the gel coating is cured. The design on the casting film is applied in the manner described herein. In one embodiment, the embossed cast film is thinner and more flexible to conform to the shape of the nail, and not impact the shape or smoothness of the cosmetic coating. While a gel coating is described, it is understood that any curable cosmetic coating is usable with the casting film.

In one embodiment, illustrated in FIG. 1, an embossed cast film which was precut into different sizes and shapes was placed on top of a curable coating, contacting the coating, which had been applied to a nail. After application, the coating was cured by ultraviolet/LED, peroxide, or other polymerization mechanism with the embossed film positioned on the curable coating. Next, the film was peeled off or rubbed off the cured coating using a conventional surface cleaning process after curing. The resulting three dimensional image on the nail was resistant to rubbing, solvent, and other forces to which a nail is conventionally exposed.

One product embodiment disclosed herein is a nano-embossed film patch usable in a curable cosmetic coating application process to generate a variety of special surface design effects such as high resolution three dimensional holographic effect images and a variety of texture effects. Another product embodiment is a sticker that adds to the three dimensional holographic effect during the printing process. The sticker and patch are, for some embodiments, applied under a coating treated with the cast film. For other embodiments, the sticker and patch are applied over the coating treated with the cast film. For some embodiments, the designs of the sticker and patch complement the design applied by the cast film.

In another embodiment with a hard top coat, the method is usable to employ nail stickers to emboss the image which maintains the durability of the image layer. The nail stickers include designs that complement designs imparted by cast films. Images are imparted to stickers using conventional printing processes disclosed herein.

Process embodiments used to make a nail sticker include direct printing and reverse printing. Direct printing is similar to current printing industry cast and cure processes. For reverse printing the cast film is used as a carrier web for the printing. This procedure allows different nail polish systems to be used including UV, solvent and water-based as long as the dried polish is hard and durable.

The embodiments are described in sufficient detail to enable those skilled in the art to practice the invention. Other embodiments may be utilized and formulation and method of using changes may be made without departing from the scope of the invention. The detailed description is not to be taken in a limiting sense, and the scope of the invention is defined only by the appended claims, along with the full scope of equivalents to which such claims are entitled.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description.

1. A cosmetic device for imparting a three dimensional micro-scale design or impressing image such as holographic and other microstructure or refractive image to a cosmetic coating applied to a nail, the device comprising:
a casting film, sized and shaped for application to the cosmetic coating applied to the nail, the casting film having a surface defining a design having three dimensions, positionable over a nail, wherein the design faces and contacts a coating on the nail, the design transferred to the coating so that the casting film is removable from the coating after the coating is cured.

2. The cosmetic device of claim 1, wherein the three dimensional design of the casting film comprises one or more of a color, image, texture, three dimensional hologram or animation.

3. The cosmetic device of claim 1, wherein the cosmetic device, further comprising an edge, having an area sized for contact by human fingers.

4. A method for imparting a three dimensional microscale design or impressing image such as holographic and other microstructure or refractive image to a cosmetic coating, the method comprising:
applying a cosmetic coating to a mammalian nail;
applying a casting film to the cosmetic coating, the casting film having a surface defining a design having three dimensions, so that the surface defining the design faces the cosmetic coating, wherein the design is transferred to the cosmetic coating
curing the cosmetic coating with the casting film; and
removing the casting film, exposing the design or image.

5. The method of claim 4, wherein the cosmetic coating is a nail gel.

6. The method of claim 4, wherein the casting film is peeled from the cured cosmetic coating.

7. The method of claim 4, wherein the casting film is removed by rubbing.

8. A cosmetic device for imparting a three dimensional microscale design or impressing image such as holographic and other microstructure or refractive image to a cosmetic coating, the device comprising:
a casting film having a surface defining a design having three dimensions, positionable over a nail, wherein the design faces and contacts an uncured coating on the nail, the design transferred to the coating so that the casting film is removable from the coating after the coating is cured.

9. (canceled)
